(19) United States
(12) Patent Application Publication
(10) Pub. No.: US 2025/0349128 A1
(43) Pub. Date: Nov. 13, 2025

(54) Method and System for Storing Video Data in a Vehicle

(71) Applicant: Bayerische Motoren Werke Aktiengesellschaft, Muenchen (DE)

(72) Inventor: Kohei OTSUKA, Unterfoehring (DE)

(21) Appl. No.: 19/200,824

(22) Filed: May 7, 2025

(30) Foreign Application Priority Data
May 8, 2024 (DE) 10 2024 113 015.6

(51) Int. Cl. G06V 20/58; G06F 21/62; G06T 3/40; G06V 10/764; G06V 20/40

(52) U.S. Cl. CPC G06V 20/58; G06F 21/6254; G06T 3/40; G06V 10/764; G06V 20/40

(57) ABSTRACT

A method for storing video data captured by automotive cameras installed in a vehicle. One or more object classes and object instances are determined within automotive sensor data, which include the video data. The determination of the one or more object classes and object instances is performed as part of one or more visual perception tasks enabling one or more driving automation system (DAS) features. Based on the determined object classes and object instances, the plurality of frames and one or more frame distances, a reduced plurality of frames is determined. For each frame not included in the reduced plurality of frames, a corresponding object list is generated, which identifies the one or more object classes and object instances determined within a corresponding frame as well as their corresponding positions. Then, the reduced plurality of frames and the object lists are stored.

### CROSS REFERENCE TO RELATED APPLICATION

This application claims priority under 35 U.S.C. § 119 from German Patent Application No. 10 2024 113 015.6, filed May 8, 2024, the entire disclosure of which is herein expressly incorporated by reference.

### TECHNICAL FIELD

The present disclosure generally relates to storing video data captured by automotive cameras and more precisely to reducing the storage size of the video data based on object detection performed by a vehicle configured to perform at least some driving automation system (DAS) functions implementing at least driver assistance.

### BACKGROUND

Modern vehicles, which implement at least some level of driving automation, perform a lot of processing of automotive sensor data in order to implement DAS functions. The automotive sensor data typically include video data captured by automotive cameras, which may be stored in the vehicle, e.g. in order to implement a event data recorder (EDR). Given the size of video data, video data may typically be compressed before being stored in order to reduce the memory footprint of the video data. While various compression techniques for video data exist, these techniques usually require additional data processing. Given that the DAS functions implemented by the vehicle already require a lot of real-time data processing, additional processing in order to compress the video data may be difficult to schedule.

Therefore, it is an objective of the present disclosure to reduce the processing effort required to compress video data in a vehicle.

### SUMMARY

To achieve this objective, the present disclosure provides a method for storing video data, which include a plurality of frames and are captured by one or more automotive cameras installed in a vehicle configured to perform at least driver assistance. The method comprises determining, within automotive sensor data, one or more object classes and one or more object instances. The automotive sensor data include the video data captured by the one or more automotive cameras, wherein the determination of the one or more object classes and the one or more object instances is performed as part of one or more visual perception tasks enabling the at least driver assistance. The method further comprises determining a reduced plurality of frames based on the one or more object classes and the one or more object instances, the plurality of frames and one or more frame distances. Each frame distance is indicative of a number of frames between frames of the plurality of frames to be excluded from the reduced plurality of frames. The method further comprises, for each frame of the plurality of frames not included in the reduced plurality of frames, generating a corresponding object list. Each object list identifies the one or more object classes and the one or more object instances determined within a corresponding frame as well as corresponding positions thereof within the corresponding frame. Finally, the method comprises storing the reduced plurality of frames and the object lists.

The present disclosure further provides an automotive control unit comprising at least one processing unit and a memory coupled to the at least one processing unit and configured to store machine-readable instructions. The machine-readable instructions cause the at least one processing unit to determine, within automotive sensor data, one or more object classes and one or more object instances. The automotive sensor data include the video data captured by the one or more automotive cameras, wherein the determination of the one or more object classes and the one or more object instances is performed as part of one or more visual perception tasks enabling the at least driver assistance. The machine-readable instructions further cause the at least one processing unit to determine a reduced plurality of frames based on the one or more object classes and the one or more object instances, the plurality of frames and one or more frame distances. Each frame distance is indicative of a number of frames between frames of the plurality of frames to be excluded from the reduced plurality of frames. The machine-readable instructions further cause the at least one processing unit to, for each frame of the plurality of frames not included in the reduced plurality of frames, generate a corresponding object list. Each object list identifies the one or more object classes and the one or more object instances determined within a corresponding frame as well as corresponding positions thereof within the corresponding frame. Finally, the machine-readable instructions further cause the at least one processing unit to store the reduced plurality of frames and the object lists.

The present disclosure further provides a vehicle comprising a plurality of sensors, and the automotive control unit.

### BRIEF DESCRIPTION OF THE DRAWINGS

Examples of the present disclosure will be described with reference to the following appended drawings, in which like reference signs refer to like components.

FIG. 1 illustrates a plurality of frames, a reduced plurality of frames and frame distances according to examples of the present disclosure.

FIG. 2 provides a flowchart of a method for storing video data including a plurality of frames and captured by one or more automotive cameras installed in a vehicle configured to perform at least driver assistance according to examples of the present disclosure.

FIG. 3 illustrates the vehicle including a plurality of automotive sensors according to examples of the present disclosure.

FIG. 4 illustrates an automotive control unit according to examples of the present disclosure.

It should be understood that the above-identified drawings are in no way meant to limit the present disclosure. Rather, these drawings are provided to assist in understanding the present disclosure. The person skilled in the art will readily understand that aspects of the present disclosure shown in one drawing may be combined with aspects in another drawing or may be omitted without departing from the scope of the present disclosure.

### DETAILED DESCRIPTION

The present disclosure generally provides a method, an automotive control unit and a vehicle configured to store video data. The vehicle includes a plurality of automotive sensors, which include one or more automotive cameras. The one or more automotive cameras are configured to capture video data, which include a plurality of frames. The video data and more generally the automotive sensor data captured by the automotive sensors is processed as part of one or more visual perception tasks, which provide the environmental awareness required for the implementation of one or more DAS features by the vehicle, such as a cruise control function or a controlled-access highway cruise feature. As part of the one or more visual perception tasks, one or more object classes and one or more object instances are determined within the automotive sensor data and thus within the video data. Based on the one or more object classes and the one or more object instances, a reduced plurality of frames is determined. That is, based on the one or more object classes and one or more object instances, one or more frame distances are determined.

The one or more frame distances are indicative of a number of frames between frames of the plurality of frames to be excluded from the reduced plurality of frames. In other words, the one or more frame distances are indicative of a number of frames which are similar in terms of the one or more object classes and the one or more object instances determined as part of the one or more visual perception tasks. As an example, the one or more object classes and the one or more object instances determined within a frame n and the subsequent k frames indicate that these frames are similar. Subsequent frame n+k+1 by contrast can no longer be considered similar given the one or more object classes and the one or more object instances determined within this frame. Accordingly, the frame distance in this example corresponds to k and only frame n and frame n+k+1 are determined to be part of the reduced plurality of frames and are accordingly stored.

For the frames within the frame distance, object lists are generated, which identify the one or more object classes and the one or more object instances determined within each corresponding frame as well as corresponding positions thereof. In other words, the object list identifies for each frame similar to frame n the object classes and object instances determined in each frame, which allows reconstruction of these frames based on stored frame n and the information included in the object lists. The object lists are thus stored instead of the actual frames, which reduces the amount of memory required to store the video data.

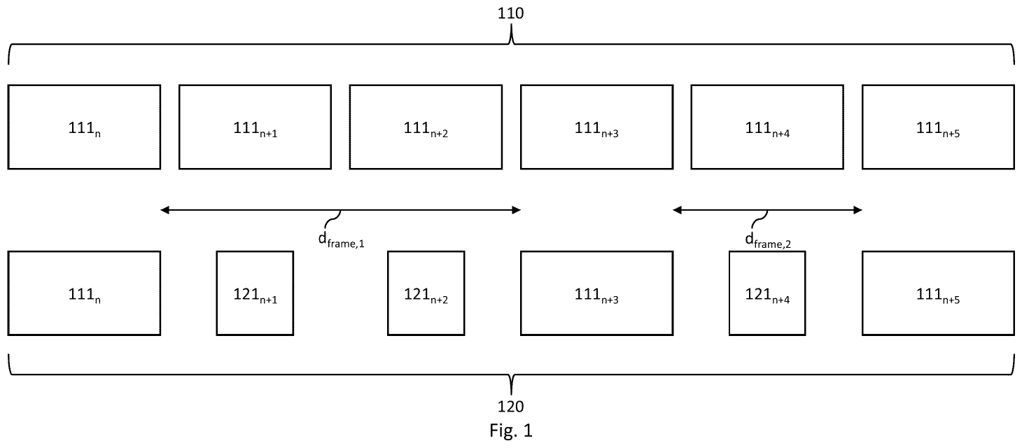

The concept of frame distances and object lists is illustrated in FIG. 1. FIG. 1 shows a plurality of frames 110, which includes frames 111ₙ to 111ₙ₊₅, a reduced plurality of frames 120, which includes frames 111ₙ, 111ₙ₊₃ and 111ₙ₊₅ as well as object lists 121ₙ₊₁, 121ₙ₊₂ and 121ₙ₊₄, and two frame distances d_{frame,1} and d_{frame,2}. It will be understood that the indices of the reference signs indicate the relationship between the frames of plurality of frames 110 on the one hand and the frames and object lists of the reduced plurality of frames 120. That is, object list 121ₙ₊₂ corresponds to frame 111ₙ₊₂ and thus identifies frame 111ₙ₊₂ by identifying the object classes and object instances within frame 111ₙ₊₂.

Frame distance d_{frame,1} indicates that frames 111ₙ to 111ₙ₊₂ are considered similar in terms of the determined object classes and object instances within these frames. Accordingly, frame distance d_{frame,1} indicates that frames 111ₙ₊₁ and 111ₙ₊₂ are excluded from reduced plurality of frames 120. Consequently, reduced plurality of frames 120 only includes object lists 111ₙ₊₁ and 111ₙ₊₂ instead of frames 111ₙ₊₁ and 111ₙ₊₂, thereby reducing the storage size of reduced plurality of frames 120 compared to the storage size of plurality of frames 110. The same applies to frame distance d_{frame,2} as well as corresponding frame 111ₙ₊₄ and object list 121ₙ₊₄.

It will be understood that the number of frames shown in FIG. 1 is merely exemplary. Since automotive cameras may capture video data with frame frates of multiple frames per second, such as 20 to 60 frames per second, both plurality of frames 110 and reduced plurality of frames 120 may include tens or hundreds of frames or more with reduced plurality of frames 120 including significantly less frames than plurality of frames 110 in view of the above-discussed frame reduction.

By determining frame distances based on the determined object classes and object instances during visual perception tasks, which are already determined in order to enable DAS functions, and by using these frame distances to reduce the storage size of video data, the data processing required in order to compress the video data can be reduced compared to regular video compression techniques used outside of vehicles. In other words, the storage size of the reduced plurality of frames is reduced by re-using data processing already performed for other functionality of the vehicle.

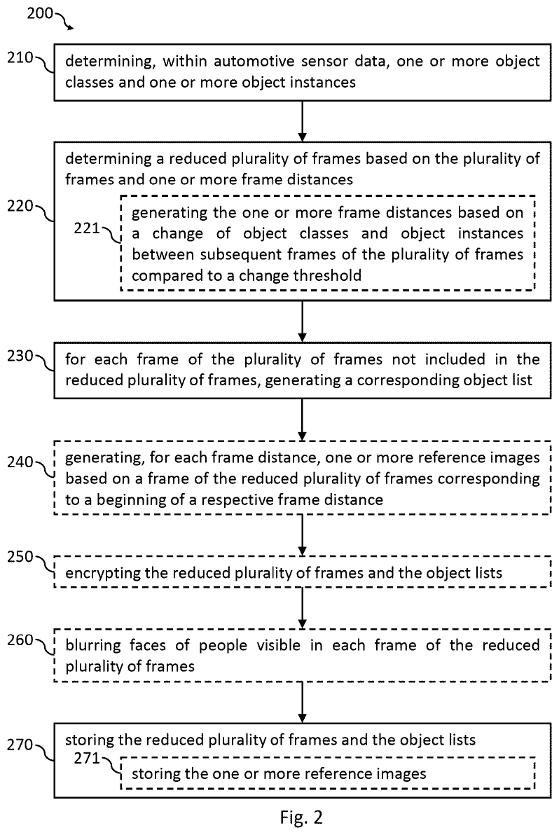

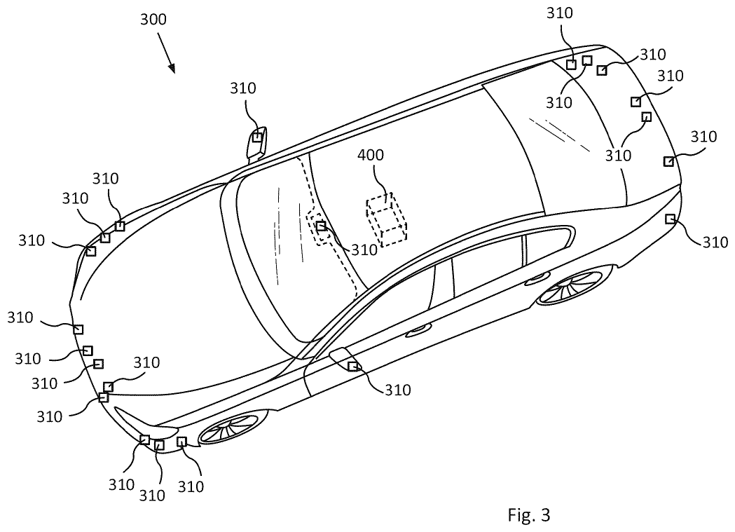

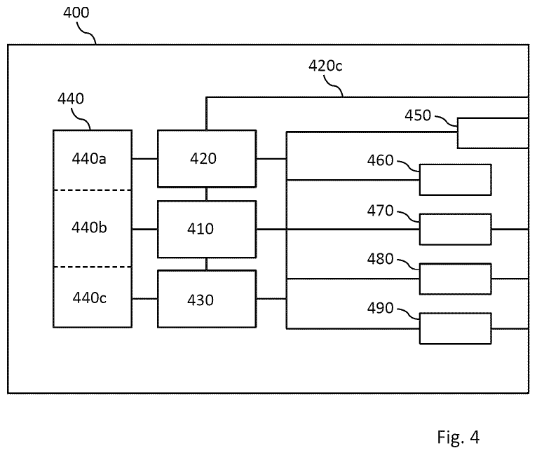

This general concept will now be explained with reference to the appended drawings, with FIG. 2 providing a flowchart of the method for storing video data captured by one or more automotive cameras installed in a vehicle. FIG. 3 illustrates the vehicle including the plurality of automotive sensors and the automotive control unit. Finally, FIG. 4 illustrates an example of the automotive control unit in more detail.

It will be understood that dashed boxes in FIG. 2 illustrate optional steps of method 200.

Method 200 is configured to store video data including plurality of frames 110, which is captured by one or more automotive cameras installed in a vehicle, such as vehicle 300 of FIG. 3, which is configured to perform at least driver assistance.

Turning briefly to FIG. 3, vehicle 300 and more generally the expression vehicle in the context of the present disclosure, refers to any kind of motor vehicle configured to transport people and/or freight. The motor of vehicle 300 may be any kind of motor, such as an electric motor or an internal combustion engine. Vehicle 300 may e.g. be a passenger vehicle as shown in FIG. 3. It will however be understood that vehicle 300 may also be a bus, a truck or any other kind of vehicle including one or more automotive sensors 310 and an automotive control unit 400 enabling vehicle 300 to perform at least driver assistance. In other words, automotive control unit 300 and one or more sensors 310 may be configured to enable vehicle 300 to provide vehicle control functionality capable of at least driver assistance. i.e. level 1 of the driving automation taxonomy defined in standard J3016 of SAE International. That is, vehicle 300 may be configured to provide at least one DAS function performing the sustained and operational design domain (ODD) specific execution by a driving automation system of either the lateral or the longitudinal vehicle motion control subtask of the dynamic driving task (DDT) (but not both simultaneously) with the expectation that the driver performs the remainder of the DDT.

ODD in the context of the present disclosure refers to the operating conditions under which a given DAS function is specifically designed to function, including, but not limited to, environmental, geographical, and time-of-day restrictions, and/or the requisite presence or absence of certain traffic or roadway characteristics.

The DDT in the context of the present disclosure includes all real-time operational and tactical functions required to operate vehicle 300 in on-road traffic, excluding strategic functions such as trip scheduling and selection of destinations and waypoints.

It will be understood that vehicle 300 may be configured to enable higher levels of driving automation, such as partial driving automation, i.e. level 2 or higher of the driving automation taxonomy defined in standard J3016 of SAE International.

It will be understood that vehicle 300 may be configured to perform DAS functions of various driving automation levels, i.e. in particular also DAS functions of lower levels of driving automation, with at least one DAS function of vehicle 300 providing driver assistance as defined in standard J3016 of SAE International.

The one or more sensors 310 are configured to capture automotive sensor data indicative of the environment of vehicle 300. Accordingly, the automotive sensor data provide environmental awareness to the one or more vehicle control modules and thereby to vehicle 300 in order to enable at least one DAS function providing driver assistance. For example, the automotive sensor data captured by the one or more sensors 310 may provide vehicle 300 with information on the position and size of other vehicles, road surface markings or traffic signs. To this end, the one or more sensors 310 may be radar sensors, which may be configured to emit radio waves in order to determine a distance, an angle and a velocity of objects around the vehicle based on the reflected radio waves. The one or more sensors 310 may be light detection and ranging (LIDAR) sensors, which are configured to emit laser beams in order to determine a distance, an angle and a velocity of objects around vehicle 300 based on the reflected laser beams. The one or more sensors 310 may be automotive cameras, which capture video data of the environment of the vehicle. The one or more sensors 310 may be thermographic cameras, which capture images of the environment of vehicle 300 based on infrared radiation. It will be understood that LIDAR sensors, radar sensors or automotive cameras are merely provided as examples of sensor types of the one or more sensors 310. For example, the one or more sensors 310 may also be ultrasonic sensors. The one or more sensors 310 may be global navigation satellite system (GNSS) sensors configured to receive positional data, such as satellite signals, for determining the position of vehicle 300. More generally, the one or more sensors 310 may be any type of sensor capable of capturing automotive sensor data indicative of the environment of vehicle 300. Further, the one or more sensors 310 may additionally be any type of sensor capable of capturing odometry data, such as speed and acceleration, of vehicle 300. This capturing capability may be integrated into the sensor types discussed above or may be provided by dedicated motion sensors. It will further be understood that the one or more sensors 310 may include multiple sensors of various types of sensors. Further, the one or more sensors 310 of the same type may exhibit different properties, e.g. by being configured to capture sensor data at different ranges, such as a close range, a middle range and a far range. For example, vehicle 300 may include three close range radar sensors each at a front and a back of vehicle 300, a middle range to far range radar sensor at the back of vehicle 300, a LIDAR sensor at the front of vehicle 300, a rear-facing camera at the back of vehicle 300, a front-facing camera at the front of the vehicle, a front-facing camera at the rear-view mirror and a rear-facing close range to middle range radar sensor in each door-mounted outer rear view mirror. It will be understood that vehicle 300 may include more or fewer automotive sensors than shown in FIG. 3 and discussed in the above example.

In step 210, method 200 determines one or more object classes and one or more object instances within the automotive sensor data, which include the video data captured by the one or more automotive cameras 310, as discussed above. The determination of the one or more object classes and the one or more object instances is performed as part of one or more visual perception tasks, which enable at least one DAS function providing driver assistance.

In the context of the present disclosure, visual perception task refers to any kind of task identifying one or more object classes and object instances, i.e. individual instances of the object classes, within the automotive sensor data captured by the one or more sensors 310 and thus within the video data. The visual perception task may for example identify within the video data provided by the one or more automotive cameras included in vehicle 300 whether vehicle 300 is located on a controlled-access highway, a limited-access road, an arterial road, a local road or a parking lot. In this example, the one or more object classes correspond to the type of road on which vehicle 300 may be located. Further, the visual perception task may for example identify within automotive sensor data provided by a LIDAR sensor and one or more automotive cameras included in vehicle 300 other vehicles and the type of vehicle, road surface markings and the type of road surface marking, road signs and the type of road sign, vulnerable road users (VRUs) as well as traffic lights and the indication state of the traffic light. Accordingly, the one or more object classes may correspond to any type of possible road user, road traffic control device and road surface marking as well as any other type of element encounterable in the driving environment of the vehicle 300 relevant for enabling at least one DAS function providing at least driver assistance. More generally, the visual perception task may thus be any perception task determining the class of objects and instances of the various classes of objects in the vicinity of vehicle 300, with the objects referring to both a determination of the general environment of vehicle 300 as well as a determination of individual elements in the vicinity of vehicle 300.

It will be understood that step 210 may already be performed as part of implementations of visual perception tasks and/or one or more DAS functions. That is, method 200 re-uses processing of the automotive sensor data and more precisely of the video data included in the automotive sensor data in order to generate and store the reduced plurality of frames as generally discussed above and discussed in more detail below. Accordingly, step 210 does not lead to added processing within automotive control unit 400 and thus does not impact processing resources of and interfere with any real-time processing performed by automotive control unit 400.

It will further be understood that, while method 200 relates to compressing video data based on object classes and object instances within video data, the determination of the object classes and the object instances in step 210 may be based on all automotive sensor data used by the one or more visual perception tasks for the object class and object instance detection. In other words, the determination of the object classes and object instances within the video data may take automotive sensor data from further automotive sensors 310 into account, which may render the determination of the object classes and object instances more robust. This may in turn improve the determination of correspondences between frames as discussed in the following with regard to step 220 and may thereby lead to smaller storage sizes of the video data.

In step 220, method 200 determines reduced plurality of frames 120 based on the one or more object classes and the one or more object instances determined in step 210 as well as plurality of frames 110 and one or more frame distances, such as frame distances d_{frame1}, d_{frame,2} shown in FIG. 1. As discussed above, each frame distance is indicative of a number of frames between frames of the plurality of frames to be excluded from the reduced plurality of frames.

The one or more frame distances may be determined based on similarities between frames 111ₙ to 111ₙ₊₅ of plurality of frames 110 in terms of the one or more object classes and the one or more object instances determined in step 210. To this end, step 220 may include a step 221, in which method 200 may generate the one or more frame distances based on a change of the object classes and the object instances between subsequent frames of the plurality of frames compared to a change threshold. The change threshold may be indicative of a percentage of object classes and object instances within a frame, such as frame 111ₙ₊₁, of plurality of frames 110 corresponding to object classes and object instances within a preceding frame, such as frame 111ₙ, of plurality of frames 110. Assuming an exemplary change threshold of 80% and ten detected objects instances and their corresponding object classes in frame 111ₙ, frame 111ₙ₊₁ with nine detected objects corresponding to the objects in frame 111ₙ may still be considered corresponding to frame 111ₙ. The same may apply to frame 111ₙ₊₂, which may include eight detected objects corresponding to the objects in frame 111ₙ. By contrast, frame 111ₙ₊₃ may only include seven detected objects corresponding to the objects in frame 111ₙ and may thus not be considered as corresponding to frame 111ₙ. Accordingly, corresponding frame distance d_{frame, 1} causes frames 111ₙ₊₁ and 111ₙ₊₂ to be excluded from reduced plurality of frames 120. More generally put, the frame distances may be determined in step 221 based on the percentage of detected object instances and their corresponding object classes corresponding to one another across a number of subsequent frames, i.e. which may only differ in terms of their position within the respective frames. In this context, the change threshold may be considered a degree of correspondence across a number of subsequent frames, below which frames may no longer be considered as corresponding to one another.

The generation of the reduced plurality of frames in steps 220 and 221 may further be based on a target storage size of reduced plurality of frames 120. To this end, the frame distances generated as part of step 220 may be determined in a manner which changes the respective frame distances. That is, if the frame distances generated in step 220 are extended, the storage size of reduced plurality 120 decreases, as more frames of plurality of frames 110 are excluded from reduced plurality 120. By contrast, if the frame distances generated as part of step 220 are shortened, the storage size of reduced plurality 120 increases as less frames of plurality of frames 110 are excluded from reduced plurality of frames 120. In the context of step 221, the extension of the frame distances and thus the reduction of the storage size of reduced plurality of frames 120 may be achieved by varying the change threshold, i.e. the change threshold may proportional to the target storage size. In other words, the degree of correspondence between frames used to generate reduced plurality of frames 120 from plurality of frames 110 may be lowered in order to exclude more frames of plurality of frames 110 from reduced plurality of frames 120.

In step 230, method 200 generates a corresponding object list for each frame 111 of plurality of frames 110 not included in reduced plurality of frames 120. Each object list identifies the one or more object classes and the one or more object instances determined within a corresponding frame 111 as well as corresponding positions thereof within the corresponding frame. That is, method 200 uses the determination of the object classes and object instances performed in step 210 to generate object lists for each frame 111 of plurality of frames 110 which is not included in reduced plurality of frames 120. The object lists define each excluded frame 111 in terms of the object instances and their corresponding classes which are included in the closest preceding frame 111 included reduced plurality 120 as well as the positions of these object instances within each excluded frame 111. Taking frame 111ₙ₊₂ of FIG. 1 as an example, corresponding object list 121ₙ₊₂ identifies the object instances and their corresponding classes visible in frame 111ₙ₊₂ by referring to the corresponding object instances and their corresponding classes in frame 111ₙ. Further, object list 121ₙ₊₂ identifies the position of these object instances and their corresponding classes in frame 111ₙ₊₂. Accordingly, method 200 reduces the storage size of reduced plurality of frames 120 compared to plurality of frames 110 by determining object lists, which takes the place of excluded frames of plurality of frames 110, as illustrated in FIG. 1. Object lists 121 are generated based on the processing performed in step 210 of method 200 and thus based on processing which is performed by automotive control unit 400 in any case in order to provide the environmental awareness necessary for one or more DAS functions.

Frames 111 excluded from reduced plurality of frames 120 can be regenerated based on their corresponding object lists 121 and their references to the closest preceding frame 111 included in reduced plurality of frames 120. For example, frame 111ₙ₊₄ in FIG. 1 is excluded from reduced plurality of frames 120 but can be regenerated based on frame 111ₙ₊₃ and object list 121ₙ₊₄.

In step 240, method 200 may generate one or more reference images based on a frame of reduced plurality of frames 120 which corresponds to a beginning of a respective frame distance. Each reference image may correspond to an object instance within the frame corresponding to the beginning of the respective frame distance. That is, in order to enable regeneration of the frames 111 excluded from reduced plurality of frames 120, method 200 may generate reference images of object instances included across a number of frames 111 of plurality of frames 120.

It will be understood that in implementations of method 200 which implement the reference image generation of step 240, even the frames at the beginning and the end of the frame distances, i.e. the frames to be included in reduced plurality of frames 120, may not be included in reduced plurality of frames 120. Rather, even for these frames only object lists may ultimately be stored in step 270, together with a library of reference images, from which all frames of plurality of frames 110 may be regenerated Such example implementations may achieve even further reduced storage sizes.

Method 200 may additionally include measures in order to protect the information included in reduced plurality of frames 120. To this end, method 200 may include a step 250, in which method 250 may encrypt reduced plurality of frames 120 and object lists 121. Reduced plurality of frames 120 and object lists 121 may be encrypted using any encryption suitable to prevent unauthorized access of reduced plurality of frames 120, such as Advanced Encryption Standard (AES) 128 or AES-256.

Method 200 may additionally include measures in order to protect the privacy of people visible in reduced plurality of frames 120. To this end, method 200 may include a step 260, in which method 200 blurs the face of people visible in each frame of reduced plurality of frames 120.

Finally, in step 270 method 200 stores the reduced plurality of frames 120 and the object lists 121. In this context, it will be understood that object lists 121 may also be considered to be part of reduced plurality of frames 120, in which object lists 121 may take the place of frames 111 of plurality of frames 120 which have been excluded from reduced plurality 120 based on the frame distances discussed above. This concept is illustrated in FIG. 1. It will further be understood that frames 111 of plurality of frames 110 included in reduced plurality of frames 120, such as frames 111ₙ, 111ₙ₊₃ and 111ₙ₊₅ in FIG. 1, may be stored as is or may be compressed by any suitable compression algorithm if required in view of the memory storage size requirements.

Step 270 may include a step 271, in which method 200 may store the one or more reference images generated in step 240. As discussed above, steps 270 and 271 may also store frames 111 determined in step 220 to be included in reduced plurality of frames 120, such as frames 111ₙ, 111ₙ₊₃ and 111ₙ₊₅ in FIG. 1, in terms of references images and object lists 121 if required in view of the memory storage size requirements.

Reduced plurality of frames 120 and object lists 121 may subsequently be used to regenerate the video data based on the references in object lists 121 to object instances and their classes in frames 111 of plurality of frames 110 included in reduced plurality 120. The regeneration may for example employ generative adversarial networks (GANs) or other deep learning techniques in order to regenerate frames 111 not included in reduced plurality of frames 120 in a realistic manner.

In summary, method 200 provides a way of storing video data captured by automotive cameras in a vehicle in a compressed manner, which re-uses data processing performed by visual perception tasks and thus reduces the processing effort associated with storing the compressed video data.

FIG. 4 shows automotive control unit 400 configured to perform method 100. Automotive control unit 400 may include a processor 410, a graphics processing unit (GPU) 420, automotive processing system 430, a memory 440, a removable storage 450, a storage 460, a cellular interface 470, a global navigation satellite system (GNSS) interface 480 and a communication interface 490.

Processor 410 may be any kind of single-core or multi-core processing unit employing a reduced instruction set (RISC) or a complex instruction set (CISC). Exemplary RISC processing units include ARM based cores or RISC V based cores. Exemplary CISC processing units include x86 based cores or x86-64 based cores. Processor 410 may perform instructions causing automotive control unit 400 to perform method 200. Processor 410 may be directly coupled to any of the components of automotive control unit 400 or may be directly coupled to memory 430, GPU 420 and a device bus.

GPU 420 may be any kind of processing unit optimized for processing graphics related instructions or more generally for parallel processing of instructions. As such, GPU 420 may be configured to generate a display of information, such as ADAS information or telemetry data, to a driver of the vehicle, e.g. via a head-up display (HUD) or a display arranged within the view of the driver. GPU 420 may be coupled to the HUD and/or the display via connection 420C. GPU 420 may further perform at least a part of method 100 to enable fast parallel processing of instructions relating to method 100. It should be noted that in some embodiments, processor 410 may determine that GPU 420 need not perform instructions relating to method 200. GPU 420 may be directly coupled to any of the components of automotive control unit 400 or may be directly coupled to processor 410 and memory 430. In some embodiments, GPU 420 may also be coupled to the device bus.

Automotive processing system 430 may be any kind of system-on chip configured to provide trillions of operations per second (TOPS) in order to enable automotive control unit 400 to implement one or more ADAS while driving. Automotive processing system 430 may interface only with processor 410 or may interface with other devices via the system bus. Automotive processing system 430 may for example perform the instructions related to the one or more automotive sensor data processing modules and to the one or more vehicle control modules.

Memory 440 may be any kind of fast storage enabling processor 410, GPU 420 and automotive processing system 430 to store instructions for fast retrieval during processing of instructions as well as to cache and buffer data. Memory 440 may be a unified memory coupled to processor 410 and GPU 420 and automotive processing system 430 in order to enable allocation of memory 440 to processor 410, GPU 420 and automotive processing system 430 as needed. Alternatively, processor 410, GPU 420 and automotive processing system 430 may be coupled to separate processor memory 440a, GPU memory 440b and automotive processing system memory 440c.

Removable storage 450 may be a storage device which can be removably coupled with automotive control unit 400. Examples include a digital versatile disc (DVD), a compact disc (CD), a Universal Serial Bus (USB) storage device, such as an external SSD, or a magnetic tape. It should be noted that removable storage 450 may store data, such as instructions of method 200, automotive sensor data, intermediate data and/or vehicle control data or may be omitted.

Storage 460 may be a storage device enabling storage of program instructions and other data. For example, storage 460 may be a hard disk drive (HDD), a solid state disk (SSD) or some other type of non-volatile memory. Storage 460 may for example store the instructions of method 100, automotive sensor data, intermediate data and/or vehicle control data.

Removable Storage 450 and storage 460 may be coupled to processor 410 via the system bus. The system bus may be any kind of bus system enabling processor 410 and optionally GPU 420 as well as automotive processing system 430 to communicate with the other devices of automotive control unit 400. Bus 440 may for example be a Peripheral Component Interconnect express (PCIe) bus or a Serial AT Attachment (SATA) bus.

Cellular interface 470 may be any kind of interface enabling automotive control unit 400 to communicate via a cellular network, such as a 4G network or a 5G network.

GNSS interface 480 may be any kind of interface enabling automotive control unit 300 to receive positional data provided by a satellite network, such as the Global Positioning System (GPS), the Global Navigation Satellite System (GLONASS) or Galileo. The positional data may be one of the types of automotive sensor data in the context of the present disclosure.

Communications interface 490 may enable automotive control unit 400 to interface with external devices, either directly or via network. Communications interface 480 may for example enable automotive control unit 400 to couple to a wired or wireless network, such as Ethernet, Wifi, a Controller Area Network (CAN) bus or any bus system appropriate in vehicles. For example, automotive control unit 400 may be coupled to the one or more automotive sensors 310 to receive automotive sensor data.

Automotive control unit 400 may be integrated with vehicle 300, e.g. beneath the cabin, under the dashboard or in the trunk of vehicle 300.

The present disclosure may further be illustrated by the following examples.

In an example, a method for storing video data including a plurality of frames and captured by one or more automotive cameras installed in a vehicle configured to perform at least driver assistance comprises determining, within automotive sensor data, one or more object classes and one or more object instances, the automotive sensor data including the video data captured by the one or more automotive cameras, wherein the determination of the one or more object classes and the one or more object instances is performed as part of one or more visual perception tasks enabling the at least driver assistance, determining a reduced plurality of frames based on the one or more object classes, the one or more object instances, the plurality of frames and one or more frame distances, each frame distance being indicative of a number of frames between frames of the plurality of frames to be excluded from the reduced plurality of frames, for each frame of the plurality of frames not included in the reduced plurality of frames, generating a corresponding object list, each object list identifying the one or more object classes and the one or more object instances determined within a corresponding frame as well as corresponding positions thereof within the corresponding frame and storing the reduced plurality of frames and the object lists.

The example method may further comprise generating, for each frame distance, one or more reference images based on a frame of the reduced plurality of frames corresponding to a beginning of a respective frame distance, each reference image corresponding to an object instance within the frame corresponding to the beginning of the respective frame distance, wherein the storing the reduced plurality of frames and the object lists may further include storing the one or more reference images.

The example method may further comprise generating the one or more frame distances based on a change of object classes and object instances between subsequent frames of the plurality of frames compared to a change threshold, wherein the change threshold may be indicative of a percentage of object classes and object instances within a frame of the plurality of frames corresponding to object classes and object instances within a preceding frame of the plurality of frames.

In the example method, the generating the one or more frame distances may further be based on a target storage size of the reduced plurality of frames, wherein the change threshold may be proportional to the target storage size.

The example method may further comprise encrypting the reduced plurality of frames and the object lists.

The example method may further comprise blurring faces of people visible in each frame of the reduced plurality of frames.

In an example, an automotive control unit comprises at least one processing unit and a memory coupled to the at least one processing unit and configured to store machine-readable instructions. The machine-readable instructions cause the at least one processing unit to determine, within automotive sensor data, one or more object classes and one or more object instances, the automotive sensor data including the video data captured by the one or more automotive cameras, wherein the determination of the one or more object classes and the one or more object instances is performed as part of one or more visual perception tasks enabling the at least driver assistance, determining a reduced plurality of frames based on the one or more object classes, the one or more object instances, the plurality of frames and one or more frame distances, each frame distance being indicative of a number of frames between frames of the plurality of frames to be excluded from the reduced plurality of frames, for each frame of the plurality of frames not included in the reduced plurality of frames, generating a corresponding object list, each object list identifying the one or more object classes and the one or more object instances determined within a corresponding frame as well as corresponding positions thereof within the corresponding frame and storing the reduced plurality of frames and the object lists.

In the example automotive control unit, the machine-readable instructions may further cause the at least one processing unit to perform any one of the preceding example methods.

In an example, a vehicle comprises a plurality of automotive sensors, and the preceding example automotive control unit.

The preceding description has been provided to illustrate a method and system for storing video data in a vehicle. It should be understood that the description is in no way meant to limit the scope of the present disclosure to the precise embodiments discussed throughout the description. Rather, the person skilled in the art will be aware that the examples of the present disclosure may be combined, modified or condensed without departing from the scope of the present disclosure as defined by the following claims.

### LIST OF REFERENCE SIGNS

110 plurality of frames
111 frame
120 reduced plurality of frames
121 object list
200 method
210-271 method steps
300 vehicle
310 automotive sensor
400 automotive control unit
410 CPU
420 GPU
420c connection
430 automotive processing system
440 memory
450 removable storage
460 storage
470 cellular interface
480 GNSS interface
490 communications interface

What is claimed is:

1. A method for storing video data including a plurality of frames captured by one or more automotive cameras installed in a vehicle configured to perform at least driver assistance, the method comprising:
determining, within automotive sensor data, one or more object classes and one or more object instances, the automotive sensor data including the video data captured by the one or more automotive cameras, wherein the determination of the one or more object classes and the one or more object instances is performed as part of one or more visual perception tasks enabling the at least driving assistance;
determining a reduced plurality of frames based on the one or more object classes, the one or more object instances, the plurality of frames, and one or more frame distances, each frame distance being indicative of a number of frames between frames of the plurality of frames to be excluded from the reduced plurality of frames;
for each frame of the plurality of frames not included in the reduced plurality of frames, generating a corresponding object list, each object list identifying the one or more object classes and the one or more object instances determined within a corresponding frame as well as corresponding positions thereof within the corresponding frame; and
storing the reduced plurality of frames and the object lists.

2. The method of claim 1, comprising:
generating, for each frame distance, one or more references images based on a frame of the reduced plurality of frames corresponding to a beginning of a respective frame distance, each reference image corresponding to an object instance within the frame corresponding to the beginning of the respective frame distance,
wherein storing the reduced plurality of frames and the object lists further includes storing the one or more reference images.

3. The method of claim 1, wherein determining the reduced plurality of frames and the one or more frame distances comprises:
generating the one or more frame distances based on a change of object classes and object instances between subsequent frames of the plurality of frames compared to a change threshold,
wherein the change threshold is indicative of a percentage of object classes and object instances within a frame of the plurality of frames corresponding to object classes and object instances within a preceding frame of the plurality of frames.

4. The method of claim 3,
wherein generating the one or more frame distances is further based on a target storage size of the reduced plurality of frames, and
wherein the change threshold is proportional to the target storage size.

5. The method of claim 1, comprising:
encrypting the reduced plurality of frames and the object lists.

6. The method of claim 1, comprising:
blurring faces of people visible in each frame of the reduced plurality of frames.

7. An automotive control unit, comprising:
at least one processing unit; and
a memory coupled to the at least one processing unit and configured to store machine-readable instructions,
wherein the machine-readable instructions cause the at least one processing unit to:
determine, within automotive sensor data, one or more object classes and one or more object instances, the automotive sensor data including video data including a plurality of frames captured by one or more automotive cameras, wherein the determination of the one or more object classes and the one or more object instances is performed as part of one or more visual perception tasks enabling at least driver assistance in a vehicle;
determine a reduced plurality of frames based on the one or more object classes, the one or more object instances, the plurality of frames, and one or more frame distances, each frame distance being indicative of a number of frames between frames of the plurality of frames to be excluded from the reduced plurality of frames;
for each frame of the plurality of frames not included in the reduced plurality of frames, generate a corresponding object list, each object list identifying the one or more object classes and the one or more object instances determined within a corresponding frame as well as corresponding positions thereof within the corresponding frame; and
store the reduced plurality of frames and the object lists.

8. The automotive control unit of claim 7, wherein the machine-readable instructions further cause the at least one processing unit to:
generate, for each frame distance, one or more references images based on a frame of the reduced plurality of frames corresponding to a beginning of a respective frame distance, each reference image corresponding to an object instance within the frame corresponding to the beginning of the respective frame distance; and
store the one or more reference images.

9. The automotive control unit of claim 7, wherein the machine-readable instructions further cause the at least one processing unit to:
determine the reduced plurality of frames and the one or more frame distances by generating the one or more frame distances based on a change of object classes and object instances between subsequent frames of the plurality of frames compared to a change threshold,
wherein the change threshold is indicative of a percentage of object classes and object instances within a frame of the plurality of frames corresponding to object classes and object instances within a preceding frame of the plurality of frames.

10. The automotive control unit of claim 9, wherein the machine-readable instructions further cause the at least one processing unit to:
generate the one or more frame distances based on a target storage size of the reduced plurality of frames,
wherein the change threshold is proportional to the target storage size.

11. The automotive control unit of claim 7, wherein the machine-readable instructions further cause the at least one processing unit to:
encrypt the reduced plurality of frames and the object lists.

12. The automotive control unit of claim 7, wherein the machine-readable instructions further cause the at least one processing unit to:
blur faces of people visible in each frame of the reduced plurality of frames.

13. A vehicle comprising:
a plurality of automotive sensors; and
the automotive control unit of claim 7.
